(19) United States
(12) Patent Application Publication
(10) Pub. No.: US 2015/0227496 A1
(43) Pub. Date: Aug. 13, 2015

(54) METHOD AND SYSTEM FOR MICROBLOG RESOURCE SHARING

(71) Applicant: Tencent Technology (Shenzhen) Company Limited, Shenzhen (CN)

(72) Inventor: Gang LIU, Shenzhen (CN)

(73) Assignee: Tencent Technology (Shenzhen) Company Limited

(21) Appl. No.: 14/693,149

(22) Filed: Apr. 22, 2015

Related U.S. Application Data
(63) Continuation of application No. PCT/CN2013/084009, filed on Sep. 23, 2013.

(30) Foreign Application Priority Data
Oct. 23, 2012 (CN) 201210407580.7

(51) Int. Cl. G06F 17/22; G06F 3/0484; H04L 29/06

(52) U.S. Cl. CPC G06F 17/2235; H04L 65/403; G06F 3/04842

(57) ABSTRACT

A method for sharing microblog resource and a system thereof are provided. The method includes: performing, by a download client device, a screenshot on a target file to obtain a target image; uploading, by the download client device, the target image to an image interface server, and acquiring a link of the target image; acquiring, by the download client device, a download link of the target file and description information of the target file; and sending, by the download client device, the download link of the target file, the link of the target image, and the description information of the target file to a microblog platform by using a microblog sharing interface server

### PRIORITY STATEMENT

The present application claims the priority and is a continuation of PCT/CN2013/084009, filed on Sep. 23, 2013 and entitled “METHOD AND SYSTEM FOR MICROBLOG RESOURCE SHARING”, which claims the priority to Chinese Patent Application No. 201210407580.7, entitled “METHOD AND SYSTEM FOR MICROBLOG RESOURCE SHARING”, filed on Oct. 23, 2012 with the Chinese State Intellectual Property Office, which are incorporated herein by reference in their entireties.

### TECHNICAL FIELD

The present disclosure relates to the field of communications network technologies, and in particular, to methods and devices for sharing microblog resource and a system thereof.

### BACKGROUND

A desktop provides a user a shortcut access interface operated by an operating system, and usually includes a graphical interface and several icons, a taskbar, and a sidebar located on the graphical interface. These icons may be specific files or folders, and may also be shortcuts to files or folders or shortcuts to applications.

Microblog, a TWITTER™-like user relationship-based platform for sharing, spreading and acquiring information, on which a user can create a personal community by using WEB, WAP, and various clients, update information with around 140 characters, and implement instant sharing. A user can use instant information formed by at most 140 characters as a microblog message anytime and anywhere, and place the microblog message on a platform connected to a network, so as to implement sharing between the user and other users. Besides, when a completely downloaded file needs to be spread, for example, shared on a microblog platform, a link and brief file description information of the downloaded file are usually spread, where the brief file description information is formed by at most 140 characters, so that other users download and view the file or spread the file again.

However, a microblog only allows a user to share a file with a description up to 140 characters. Consequently only a small amount of information about the shared file can be displayed on a microblog. Because of this, a reader of the microblog often times cannot accurately determine information of the shared file by reading the 140-character description.

### SUMMARY

According to the embodiments of the present disclosure, a method for sharing microblog resource and a system thereof. A target file can be displayed by using an image, and a large amount of information is displayed, so that a user can accurately determine whether to share the file.

According to one aspect, a method for sharing microblog resource is provided in an embodiment of the present disclosure, which includes: providing an electronic device in communication with a microblog platform and an image interface server, the image interface server being in communication with the microblog platform; performing, by the electronic device, a screenshot to a target file to generate multiple screenshot images; selecting, by the electronic device, a target image from the multiple screenshot images; uploading, by the electronic device, the target image to the image interface server; acquiring, by the electronic device, a link of the target image from the image interface server; sending, by the electronic device, the download link of the target file, the link of the target image, and the description information of the target file to the microblog platform.

According to another aspect, a system for sharing microblog resource is provided in an embodiment of the present disclosure, which includes: a download client device, configured to perform a screenshot on a target file to obtain a target image; upload the target image to an image interface server, and acquire a link of the target image; the image interface server, configured to receive the target image, and return the link of the target image to the download client device, where the download client device is further configured to acquire a download link of the target file and description information of the target file, and send the download link of the target file, the link of the target image, and the description information of the target file to a microblog platform by using a microblog sharing interface server; and the microblog platform, configured to receive the download link of the target file, the link of the target image, and the description information of the target file.

According to yet another aspect, an electronic device is provided in an embodiment of the present disclosure, which includes: a storage medium comprising a set of instructions for sharing microblog resource; and a processor in communication with the storage medium, wherein when executing the set of instructions the processor is directed to: establish a communication with a microblog platform and an image interface server, the image interface server being in communication with the microblog platform; perform a screenshot to the target file to generate a plurality of screenshot images; select a target image from the plurality of screenshot image; upload the target image to the image interface server; acquire a link of the target image from the image interface server; acquire a download link associated with the target file; and send the download link of the target file and the link of the target image to the microblog platform.

In a method for sharing microblog resource and a system thereof provided in the embodiments of the present disclosure, a download client device performs a screenshot on a target file to obtain a target image; uploads the target image to an image interface server, and acquires a link of the target image; acquires a download link of the target file and description information of the target file; and sends the download link of the target file, the link of the target image, and the description information of the target file to a microblog platform. Compared with other technology in which description information of a shared file can only be formed by at most 140 characters, and consequently a small amount of information is displayed; as a result, information of the shared file cannot be accurately determined, in the solutions provided in the embodiments of the present disclosure, a screenshot is performed on the target file, and information of the target file is displayed by using an image, so that a large amount of information is displayed, and a user can accurately determine whether to share the file.

### BRIEF DESCRIPTION OF THE DRAWINGS

To illustrate the technical solutions in the embodiments of the present disclosure, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a flowchart of a method for sharing microblog resource according to an embodiment of the present disclosure;

FIG. 2 is a flowchart of another method for sharing microblog resource according to an embodiment of the present disclosure;

FIG. 3 is a schematic diagram of a system for sharing microblog resource according to an embodiment of the present disclosure; and

FIG. 4 is a schematic diagram of another system for sharing microblog resource according to an embodiment of the present disclosure.

### DETAILED DESCRIPTION

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

The method as disclosed as following may be implemented by any appropriate computing device having one or more processors and memory. The computing device, used herein, may refer to any appropriate device with certain computing capabilities (e.g., of controlling media data to be placed at a constant speed), such as a personal computer (PC), a work station computer, a hand-held computing device (tablet), a mobile terminal (a mobile phone or a smart phone), a sever, a network server, a smart terminal, or any other user-side or server-side computing device. The memory includes storage medium, which may further include memory modules, e.g., Read-Only Memory (ROM), Random Access Memory (RAM), and flash memory modules, and mass storages, e.g., CD-ROM, U-disk, removable hard disk, etc., which are all non-transitory storage medium. The storage medium may be a non-transitory computer readable storage medium that stores computer programs for implementing various processes, when executed by the processors.

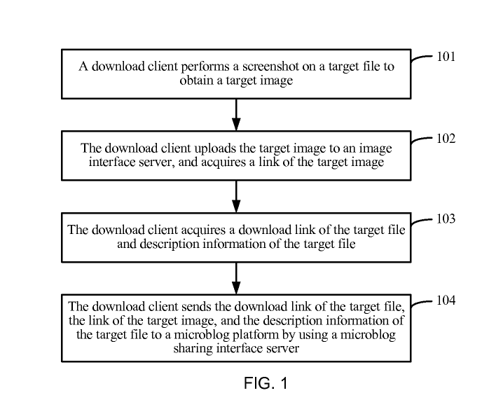

According to an embodiment of the present disclosure, it is provided a method for sharing microblog resource. As shown in FIG. 1, the method includes steps 101 to 104.

In step 101, a download client device performs a screenshot on a target file (e.g., a target file) to obtain a target image (e.g., a target image).

A message in a microblog is usually formed by texts of at most around 140 characters. The message can be shared instantly. However, in a microblog message only formed by text information of around 140 characters, there is a small amount of disclosed information. Besides, text information has a limited description capability, and file information is neither intuitively understood by a user, nor quickly determined by the user. As a result, few download links of the microblog are converted into effectively clicked download links. In this embodiment of the present disclosure, a screenshot is performed on the target file, and information is displayed more intuitively by using an image. In this way, a user acquires a large amount of information, and the number of clicked download links increases.

The target file is a file that a user intends to upload to a microblog platform, and to make other users share and spread the file.

Further, in this step, the download client device performs a screenshot on the target file to generate screenshots of different specifications, for example, screenshots of three different specifications, namely, a large image, a middle-sized image, and a small image may be generated. The large image may be an original image uploaded by a user; the middle-sized image is represented by pixels as follows: 400*400, and the middle-sized image is an image viewed when a thumbnail is clicked; and the small image is usually an image that is represented by a thumbnail by using a specification of 32*32.

The download client device calculates, based on a measured upload bandwidth of a user, durations taken to upload the screenshots of different specifications to the microblog platform, so that the user selects an appropriate target image; and the download client device obtains the target image based on the selection of the user.

In step 102, the download client device uploads the target image to an image interface server, and acquires a link of the target image.

In this step, after receiving the target image, the image interface server sends the target image to an image database for storing. The image database returns an address to which the target image is stored to the image interface server. And the image interface server generates a link of the target image according to the address to which the target image is stored, and sends the link of the target image to the download client device, so that the download client device can obtain the link of the target image.

When receiving a target image with a high resolution sent by the download client device, the image interface server is further configured to convert the target image with the high resolution into images of different resolutions.

In step 103, the download client device acquires a download link of the target file and description information of the target file.

The download client device may acquire the download link of the target file from a file that is displayed on the microblog platform and shared by another user, that is, the download client device directly acquires the download link of the target file shared by the another user.

The description information of the target file includes a size of the target file, a name of the target file, an average file download speed, or a bit rate and a resolution. If the target file is a text file, the description information of the target file is a size, a file name, and an average download speed of the target file that are extracted; and if the target file is a multimedia file, the description information of the target file may be a name, an author, a bit rate, a resolution, and the like of the album, where the multimedia file may be an audio file and a video file in various formats.

In step 104, the download client device sends the download link of the target file, the link of the target image, and the description information of the target file to a microblog platform by using a microblog sharing interface server.

The microblog sharing interface server is configured to encapsulate a microblog platform operation interface, acquire a microblog relationship link, verify a connection relationship between users, where the connection relationship includes, for example, that a user is a follower of another user; the microblog sharing interface server is further configured to communicate with the download client device, and send the description information of the target file of the user, the image of the target file, and the links of corresponding content to the microblog platform.

When a user updates his/her microblog content, multiple pieces of information of the target file may be displayed, where the target image and the description information of the target file may be displayed, which is provided as a reference about whether the user needs to download the target file.

The microblog platform may acquire the target image from the image database according to the link of the target image uploaded by the download client device, and display the target image.

According to this embodiment of the present disclosure, it is provided a method for sharing microblog resource. Screenshot processing is performed on a target file to obtain a target image, and a link of the target image, a download link of the target file, and description information of the target file that are obtained are sent to a microblog platform, to make the microblog platform display the target image and the description information of the target file. In this way, a large amount of information is displayed, and a user can accurately determine whether to share the target file.

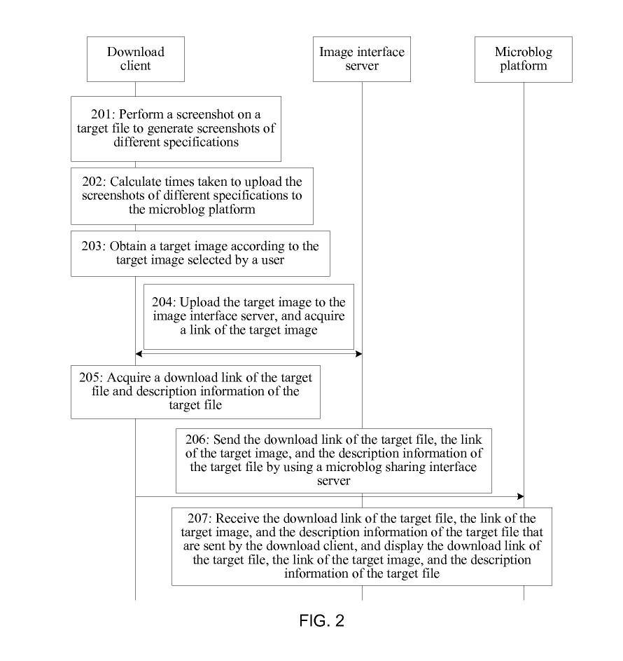

According to an embodiment of the present disclosure, it is provided another method for sharing microblog resource. As shown in FIG. 2, the method includes steps 201 to 207.

In step 201, a download client device performs a screenshot on a target file to generate screenshots of different specifications.

The target file is a file that a user intends to upload to a microblog platform and to make other users share and spread the file.

In this embodiment, the download client device performs a screenshot on the target file to generate images of different specifications, for example, screenshots of three different specifications, namely, a large image, a middle-sized image, and a small image may be generated. The large image may be an original image uploaded by a user; the middle-sized image is represented by pixels as follows: 400*400, and the middle-sized image is an image viewed when a thumbnail is clicked; and the small image is usually an image that is represented by a thumbnail by using a specification of 32*32.

For example, the target file is a video file; and screenshots may be taken according to different time lengths of the video file at the head, in the middle, and at the tail of the video file. In consideration of that the head and tail of the video file are usually caption and text introduction information, and compared with the middle of the video, which include less useful information of the video file. Therefore, it is necessary to determine whether the generated images include a large amount of useful information. The download client device may calculate an average luminance value of the generated images. Generally, because the head and tail of the video file include a large amount of caption and text introduction information, an average luminance value at the head and tail of the video file is small.

The average luminance value obtained by calculation is compared with a luminance threshold; and the generated images of different specifications determined as the screenshots when the average luminance value is greater than or equal to a luminance threshold; or when the average luminance value is less than a luminance threshold, screenshot is performed on the target file again, an average luminance value of generated images is calculated, and the average luminance value is then compared with the luminance threshold, where the luminance threshold is a value set based on experience.

In step 202, the download client device calculates, based on a measured upload bandwidth of a user, durations taken to upload (i.e., upload time) the screenshots of different specifications to a microblog platform, so that the user selects an appropriate the target image.

The user may determine to select an appropriate screenshot as the target image based on the durations taken to upload the screenshots of different specifications.

In step 203, the download client device obtains the target image based on the selection.

In step 204, the download client device uploads the target image to an image interface server, and acquires a link of the target image.

In this step, the download client device acquires the link of the target image mainly in the following manner: the download client device uploads the target image to the image interface server; the image interface server sends the target image to the image database; the image database stores the target image, and sends an address to which the target image is stored to the image interface server; the image interface server generates the link of the target image according to the address to which the target image is stored, and the image interface server sends the link of the target image to the download client device; and the download client device receives the link of the target image.

According to an embodiment of the present disclosure, the image interface server is configured to receive the images of different specifications uploaded by the download client device, return a link corresponding to the images of different specifications. When receiving an image with a high resolution, the image interface server is configured to provide a service of converting the image with the high resolution into images of different resolutions; in addition, the image interface server is configured to store the received images to an image database.

In step 205, the download client device acquires a download link of the target file and description information of the target file.

Specifically, the acquiring, by the download client device, the download link of the target file is included in the existing technology, which is not described herein one by one.

The description information of the target file includes a size of the target file, a name of the target file, an average file download speed, or a bit rate and a resolution. If the target file is a text file, the description information of the target file is a size, a file name, and an average download speed of the target file that are extracted; and if the target file is a multimedia file, the description information of the target file may be a name, an author, a bit rate, a resolution, and the like of the album, where the multimedia file may be an audio file and a video file in various formats.

In step 206, the download client device sends the download link of the target file, the link of the target image, and the description information of the target file to the microblog platform by using a microblog sharing interface server.

The microblog sharing interface server is configured to encapsulate a microblog platform operation interface, acquire a microblog relationship link, verify a connection relationship between users, communicate with the download client device, and send the description information of the target file of the user, the image of the target file, and the links of corresponding content to the microblog platform.

In step 207, the microblog platform receives and displays the download link of the target file, the link of the target image, and the description information of the target file that are sent by the download client device.

The microblog platform acquires the target image from the image database according to the link of the target image when a user loads a microblog page on which the target file is located; and displays the target image on the microblog page.

The description information of the target file and the download link of the target file are also displayed on the microblog page. A user can obtain abundant and accurate information description of the target file by the displayed the target image and the description information of the target file, so that the user can determine information of the target file more quickly, thereby increasing the number of download links of the target file converted into effectively clicked download links. Besides, the user instantly determines quality of the shared file more easily by using the image, and therefore quickly determines whether the shared file needs to be downloaded or continues to be spread, which can improve user experience.

It should be noted that the download client device is further configured to periodically report an online situation and local resource information to a tracker server. That is, the download client device reports, when the download client device goes online, to the tracker server that the download client device is currently online, so that the tracker server receives an online situation report of the download client device, generates a node list of resources, and a feedback when a download task is performed on a node. The local resource information includes a unique identification hash, an Internet Protocol (IP) address and port, a file size, a file name, and the like of a local file.

The download client device is further configured to query a uniform/universal resource locator (URL) set of resources and hash and file verification information from the resource index server by using URLs of the resources; the resource index server receives a file hash of an entry query by the download client device by using URLs as an index, and a resource set of URLs downloaded in response to the entry query performed by using URLs as an index; the download client device downloads data from a URL set source; and additionally, the resource index server is further configured to provide file fragment verification information, to allow the download client device to verify validity of the downloaded data.

Besides, the download client device is further configured to query a node from the tracker server; report, to the statistic server after fulfilling a download task, a download time, a download speed, a download result, a file size, an original download link, and download speeds and download times of acquisition of different URL sources of the current download task; and perform verification after discovering in a download process that a completed data fragment is downloaded, report to the statistic server if discovering that the fragment is mistaken, and the like.

According to this embodiment of the present disclosure, it is provided a method for sharing microblog resource. Screenshot is performed on a target file to obtain a target image, and a link of the target image, a download link of the target file, and description information of the target file that are obtained are sent to a microblog platform, to make the microblog platform display the target image and the description information of the target file. In this way, a large amount of information is displayed, and a user can accurately determine whether to share the target file.

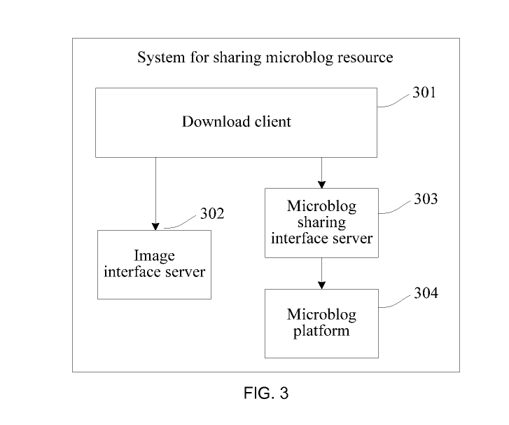

According to an embodiment of the present disclosure, it is provided a system for sharing microblog resource. As shown in FIG. 3, the system includes: a download client device 301, an image interface server 302, a microblog sharing interface server 303, and a microblog platform 304.

The download client device 301 is configured to perform a screenshot on a target file to obtain a target image, where the target file is a file that a user intends to upload to the microblog platform, and to make other users share and propagate the file; and upload the target image to the image interface server 302, and acquire a link of the target image.

The image interface server 302 is configured to receive the target image uploaded by the download client device, and return the link of the target image to the download client device.

The download client device 301 is further configured to acquire a download link of the target file and description information of the target file, where the description information of the target file includes a size of the target file, a name of the target file, an average file download speed, or a bit rate and a resolution; the download client device 301 is further configured to send the download link of the target file, the link of the target image, and the description information of the target file to the microblog platform 304 by using the microblog sharing interface server 303.

Further, the microblog sharing interface server 303 is configured to encapsulate a microblog platform operation interface, acquire a microblog relationship link, verify a connection relationship between users, communicate with the download client device 301, and send the description information of the target file of a user, the image of the target file, and the links of corresponding content to the microblog platform 304.

The microblog platform 304 is configured to receive the download link of the target file, the link of the target image, and the description information of the target file.

Further, in performing a screenshot on the target file to obtain the target image, the download client device 301 is configured to perform a screenshot on the target file to generate screenshots of different specifications; calculate, based on a measured upload bandwidth of a user, durations taken to upload the screenshots of different specifications to the microblog platform, to allow the user to select an appropriate target image; and obtain the target image based on the selection of the user.

Further, in performing a screenshot on the target file to generate the screenshots of different specifications, the download client device 301 is configured to perform a screenshot on the target file to generate images of different specifications; calculate an average luminance value of the images; and determine a generated image as the screenshots when the average luminance value is greater than or equal to a luminance threshold; or perform a screenshot on the target file again when the average luminance value is less than a luminance threshold.

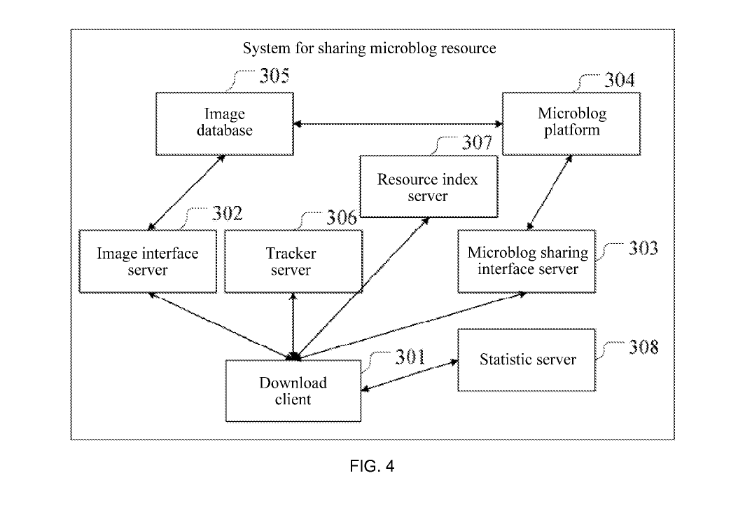

Further, as shown in FIG. 4, when the download client device acquires the link of the target image, the system further includes an image database 305.

The download client device 301 is configured to upload the target image to the image interface server 302.

The image interface server 302 is configured to receive the target image uploaded by the download client device, and send the target image to the image database 305.

The image database 305 is configured to receive the target image sent by the image interface server 302, store the target image, and send an address to which the target image is stored to the image interface server 302.

The image interface server 302 is further configured to receive the address of the target image sent by the image database 305, generate the link of the target image according to the address to which the target image is stored, and send the link of the target image to the download client device 301.

The download client device 301 is further configured to receive the link of the target image.

When receiving an image with a high resolution, the image interface server 302 is further configured to provide a service of converting the image with the high resolution into images of different resolutions.

Further, the microblog platform 304 is configured to acquire the target image from an image database according to the link of the target image when a user loads a microblog page on which the target file is located, and display the target image on the microblog page.

Further, as shown in FIG. 4, the system further includes: a tracker server 306, a resource index server 307, and a statistic server 308.

The download client device 301 is further configured to periodically report an online situation and local resource information to the tracker server 306. That is, the download client device reports, when the download client device goes online, to the tracker server 306 that the download client device is currently online, so that the tracker server 306 receives an online situation report of the download client device 301, generates a node list of resources, and a feedback when a download task is performed on a node. The local resource information includes a unique identification hash, an IP address and port, a file size, a file name, and the like of a local file.

The download client device 301 is further configured to query a uniform/universal resource locator (URL) set of multiple resources and hash and file verification information from the resource index server 307 by using URLs of the multiple resources; the resource index server 307 receives a file hash of an entry query by the download client device by using URLs as an index, and a resource set of multiple URLs downloaded in response to the entry query performed by using URLs as an index; the download client device downloads data from a URL set source; and the resource index server 307 is further configured to provide file fragment verification information, to allow the download client device to verify validity of the downloaded data.

Besides, the download client device 301 is further configured to query a node from the tracker server 306; report, to the statistic server 308 after fulfilling a download task, a download time, a download speed, a download result, a file size, an original download link, and download speeds and download times of acquisition of different URL sources of the current download task; and perform verification after discovering in a download process that a completed data fragment is downloaded, report to the statistic server 308 if discovering that the fragment is mistaken, and the like.

According to this embodiment of the present disclosure, it is provided a system for sharing microblog resource. Screenshot is performed on a target file to obtain a target image, and a link of the target image, a download link of the target file, and description information of the target file that are obtained are sent to a microblog platform, to make the microblog platform display the target image and the description information of the target file. In this way, a large amount of information is displayed, and a user can accurately determine whether to share the target file.

The foregoing descriptions are merely specific embodiments of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

1. A method for sharing microblog resource, comprising:
providing an electronic device in communication with a microblog platform and an image interface server, the image interface server being in communication with the microblog platform;
performing, by the electronic device, a screenshot to a target file to generate a plurality of screenshot images;
selecting, by the electronic device, a target image from the plurality of screenshot image;
uploading, by the electronic device, the target image to the image interface server;
acquiring, by the electronic device, a link of the target image from the image interface server;
acquiring, by the electronic device, a download link and description information associated with the target file; and
sending, by the electronic device, the download link of the target file, the link of the target image, and the description information of the target file to the microblog platform.

2. The method according to claim 1, wherein each of the plurality of screenshot images comprises an image specification; and
the selecting of the target image comprises:
for each of the plurality of the screenshot images, calculating an upload time to upload the screenshot image to the microblog platform based on a measured upload bandwidth for a user and the specification of the screenshot image; and
receiving from the user the selection of the target image from the plurality of screenshot images based on the calculated durations.

3. The method according to claim 1, wherein the generation of the plurality of screenshot image comprises:
performing a screenshot to the target file to generate a plurality of candidate images, each of the plurality of candidate images comprises an image specification;
calculating an average luminance value of the plurality of candidate images; and
determining the plurality of candidate images as the plurality of screenshot images when the average luminance value is greater than a luminance threshold; and
performing another screenshot to the target file again when the average luminance value is less than the luminance threshold.

4. The method according to claim 1, wherein when the target image is of a high resolution, the link is associated with an image generated by the image interface server by lowering the resolution of the target image.

5. The method according to claim 1, wherein the specification comprises a resolution of the corresponding image; and
each of the plurality of screenshot images of different specifications are obtained by converting an image with a high resolution to the resolution corresponding to the screenshot image.

6. The method according to claim 1, wherein the description information of the target file comprises at least one of a size of the target file, a name of the target file, an average file download speed, a bit rate, and a resolution of the file.

7. An electronic device, comprising:
a storage medium comprising a set of instructions for sharing microblog resource; and
a processor in communication with the storage medium, wherein when executing the set of instructions the processor is directed to:
establish a communication with a microblog platform and an image interface server, the image interface server being in communication with the microblog platform;
perform a screenshot to the target file to generate a plurality of screenshot images;
select a target image from the plurality of screenshot image;
upload the target image to the image interface server;
acquire a link of the target image from the image interface server;
acquire a download link associated with the target file; and
send the download link of the target file and the link of the target image to the microblog platform.

8. The electronic device according to claim 7, wherein each of the plurality of screenshot images comprises an image specification; and
to select the target image comprises, the processor if further directed to:
for each of the plurality of the screenshot images, calculate an upload time to upload the screenshot image to the microblog platform based on a measured upload bandwidth for a user and the specification of the screenshot image; and
receive from the user the selection of the target image from the plurality of screenshot images based on the calculated durations.

9. The electronic device according to claim 7, wherein to generate the plurality of screenshot image, the processor is further directed to:
perform a screenshot to the target file to generate a plurality of candidate images;
calculate an average luminance value of the plurality of candidate images; and
determine the plurality of candidate images as the plurality of screenshot images when the average luminance value is greater than a luminance threshold; and
perform another screenshot to the target file again when the average luminance value is less than the luminance threshold.

10. The electronic device according to claim 7, wherein when the target image is of a high resolution, the ink is associated with an image generated by the image interface server by lowering the resolution of the target image.

11. The electronic device according to claim 7, wherein the resolution comprises a resolution of the corresponding image; and
each of the plurality of screenshot images of different resolutions are obtained by converting an image with a high resolution to the resolution corresponding to the screenshot image.

12. A system for sharing microblog resource, comprising:
a download client device, configured to
perform a screenshot on a target file to obtain a target image,
upload the target image to an image interface server, and
acquire a link of the target image;
the image interface server, configured to
receive the target image, and
return the link of the target image to the download client device,
the download client device is further configured to
acquire a download link of the target file and description information of the target file, and
send the download link of the target file, the link of the target image, and the description information of the target file to a microblog platform by using a microblog sharing interface server; and
the microblog platform, configured to
receive the download link of the target file, the link of the target image, and the description information of the target file.

13. The system according to claim 12, wherein the download client device is configured to:
perform the screenshot on the target file to generate a plurality of screenshot images of different resolutions;
calculate, based on a measured upload bandwidth of a user, an upload time to upload the plurality of screenshot images to the microblog platform,
receive a selection of the target image from the plurality of screenshot images from the user based on the upload time; and
obtain the target image based on the selection of the user.

14. The system according to claim 13, wherein the download client device is configured to:
perform a screenshot on the target file to generate images of different resolutions;
calculate an average luminance value of the images; and
determine the generated images of different resolutions as the screenshot images when the average luminance value is greater than a luminance threshold; and
perform screenshot on the target file again when the average luminance value is less than the luminance threshold.

15. The system according to claim 14, wherein:
the download client device is configured to upload the target image to the image interface server;
the image interface server is configured to receive the target image uploaded by the download client device, and send the target image to an image database;
the image database is configured to receive the target image sent by the image interface server, store the target image, and send an address to which the target image is stored to the image interface server;
the image interface server is further configured to receive the address of the target image sent by the image database, generate the link of the target image according to the address to which the target image is stored, and send the link of the target image to the download client device; and
the download client device is further configured to receive the link of the target image.

16. The system according to claim 15, wherein when the image interface server receives a target image with a high resolution sent by the download client device, the image interface server is further configured to convert the target image into images of different resolutions.

17. The system according to claim 12, wherein the description information of the target file comprises a size of the target file, a name of the target file, an average file download speed, or a bit rate and a resolution.

18. The system according to claim 12, wherein:
the microblog platform is configured to acquire the target image from an image database according to the link of the target image when a user loads a microblog page on which the target file is located, and display the target image on the microblog page.

19. The system according to claim 12, wherein:
the microblog sharing interface server is configured to encapsulate a microblog platform operation interface, acquire a microblog relationship link, verify a connection relationship between users, communicate with the download client device, and send the description information of the target file, the link of the target image, and the download link of the target file to the microblog platform.

20. The system according to claim 12, further comprising:
a tracker server, a resource index server, and a statistic server, wherein:
the download client device is further configured to periodically report an online status and local resource information to the tracker server, to make the tracker server receive an online situation report of the download client device, generate a node list of resources and a feedback when a download task is performed on a node;
the download client device is further configured to query a uniform resource locator (URL) set of resources and hash and file verification information from the resource index server by using URLs of the resources;
the resource index server is configured to receive a file hash of an entry query by the download client device by using URLs as an index and a resource set of URLs downloaded in response to the entry query performed by using URLs as an index;
the download client device is configured to download data from a URL set source; and
the resource index server is further configured to provide file fragment verification information, to allow the download client device to verify validity of the downloaded data; and query a node from the tracker server; report, to the statistic server after fulfilling a download task, a download time, a download speed, a download result, a file size, an original download link, and download speeds and download times of acquisition of different URL sources of the current download task; and perform verification after discovering in a download process that a completed data fragment is downloaded, and report to the statistic server when discovering that the fragment is mistaken.
